(19) United States
(12) Patent Application Publication
(10) Pub. No.: US 2007/0275654 A1
(43) Pub. Date: Nov. 29, 2007

(54) Broadcast information managing system, method of managing broadcast information, and receiving apparatus, mobile terminal apparatus and a recording medium used in broadcast information managing system

(75) Inventor: Makoto Danjyo, Tokorozawa-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 11/804,053

(22) Filed: May 16, 2007

(30) Foreign Application Priority Data
May 23, 2006 (JP) 2006-142219

(51) Int. Cl. H04H 1/00

(52) U.S. Cl. 455/3.01

(57) ABSTRACT

A receiving apparatus extracts a bookmark of a data broadcast when a bookmark acquisition switch is turned on while receiving the data broadcast for discriminating program information and content data, and records the bookmark on a memory card. When content data is recorded on the memory card, the receiving apparatus reads the bookmark from the memory card and displays the bookmark on a display section. A cellular phone apparatus is connected to a network in accordance with the bookmark recorded on the memory card, and acquires content data and records the acquired content data on the memory card.

### CROSS REFERENCE TO RELATED APPLICATION

The present patent application is based upon and claims the benefit of priority from the prior Japanese Patent Application No. 2006-142219, file May 23, 2006, the entire contents of which are incorporated herein by reference.

### BACKGROUND OF THE INVENTION

1. Field of the Invention

The present invention relates to a broadcast information managing system, a method of managing broadcast information, a receiving apparatus, communication terminal apparatus, and a storage medium, used in the broadcast information managing system.

2. Description of the Related Art

In the digital television broadcasts using telecommunication satellites and broadcasting satellites, or the terrestrial digital television broadcasts and digital radio broadcasts, service of which will start throughout all parts of Japan in the year of 2011 in place of the analog broadcasts, data broadcasts are included in addition to main information such as video information and audio information to supply various sorts of additional information. Various proposals have been made to select and acquire desired information from among the received data broadcasts. For example, some of these proposals use a Web page browsing function or a bookmark function, which previously registers Web sites or Web pages in a register, in which a user is interested, or to which the user accesses frequently. To use the bookmark function, the user associates URL (Uniform Resource Locator) of Web page that is currently displayed on a personal computer with a short cut such as a daily term and registers the URL associated with the short cut in the register. Then, the user can access to his or her desired Web page by simply selecting the corresponding short cut from among a list of shorts cuts displayed on a monitor. Therefore, attention is focused on the bookmark function as a convenient tool for accessing to data broadcasts.

For example, using a receiving apparatus disclosed in JP 2002-217761 A, the user can collect and record in a memory additional information that he or she needs without performing troublesome operation such as manipulating a record button. This receiving apparatus is for receiving digital radio broadcasts carrying audio information with additional information multiplexed. When the record button is pressed while the receiving apparatus is receiving a television program, additional information relating to such television program is automatically stored in the memory as a bookmark, and when call operation is executed with the additional information recorded in the memory, the additional information is read from the memory and displayed on LCD. Further, a touch panel is touched with a touch pen with additional information displayed on LCD to designate a character string or a part of the additional information, the designated character string is set as a key word. A system controller of the receiving apparatus records the additional information in the memory, when the additional information of the program to be received includes the key word.

Using a cellular phone and the like disclosed in JP 2005-020345 A, the user selects his or her desired one among broadcast related information such as CM of digital broadcasts and can reproduce the one on an apparatus such as a personal computer connected to a network such as the Internet without performing troublesome operation. The cellular phone receives digital TV broadcasts through a satellite digital broadcasting network, and extracts URL information relating to CM, and stores the information in a built-in storage. When the cellular phone is set onto its cradle connected to the personal computer, the information stored in the storage of the cellular phone is automatically transferred to a storage of the personal computer. In the personal computer, the URL information transferred from the cellular phone is registered as a bookmark. Selecting registered URL information, the user of the computer can access CM information database through the Internet.

Meanwhile, Electronic Program Guide (EPG) has been proposed as additional information of the digital TV broadcasts. This Electronic Program Guide can be used for later recording of scheduled broadcast programs. For example, in a program-record scheduling system disclosed in JP 2004-363881 A, when Electronic Program Guide is received, a program-record scheduling operation can be performed using the received Electronic Program Guide, even though a decoding circuit is not provided to decode the Electronic Program Guide. The program-record scheduling system has an information receiving unit for acquiring an electronic program listing from the received Electronic Program Guide, and storing the electronic program listing in a storage unit, and a recording unit for reading the electronic program listing from the storage unit. The recording unit schedules for recording of broadcast programs using the electronic program listing read from the storage unit.

However, in the receiving apparatus disclosed in JP 2002-217761 A, it is not possible to access to a home page in accordance with the additional information or a part (key word of the additional information stored in the memory to acquire information relating to television programs. The cellular phone disclosed in JP 2005-020345 A needs a tuner for receiving digital television broadcasts and a battery having a large battery capacity. Both elements are very expensive. As a result, the cellular phone rises in a retail price. In the program-record scheduling system disclosed in JP 2004-363881 A, it is possible to schedule for later recording of broadcast programs using a memory card, but it is impossible to acquire additional information other than the Electronic Program Guide including, for example, URLs of home pages of performers and event information of the performers, or music titles in a broadcast music program and names of the artists.

The conventional systems described above do not provide environment, in which user's resources such as conventional receiving apparatuses having no most widely used communication function and cellular phones having no digital broadcast receiving function can effectively be used to enjoy the additional information of the digital broadcasts.

### SUMMARY OF THE INVENTION

The present invention has been made to solve problems involved in the conventional systems or apparatuses, and has an object to provide a technology for acquiring data broadcasts or addition information of satellite digital television broadcasts, terrestrial digital television broadcasts and digital radio broadcasts, by using a conventional receiving apparatus having no electronic communication function and a conventional cellular phone having no digital-broadcast receiving function.

According to one aspect of the present invention, there is provided a broadcast information managing system comprising a receiving apparatus for receiving digital broadcasts, a mobile terminal apparatus having a communication function for communicating with a network, and a memory for storing information, wherein the receiving apparatus comprises information extracting means for extracting additional information when a predetermined operation is performed while receiving additional information for designating program information and information relating to a television program, first record controlling means for recording in the memory the additional information extracted by the information extracting means, displaying means for displaying information, and display controlling means for reading the information relating to a television program from the memory to display the read information on the displaying means, when the information relating to a television program is recorded in the memory, and the mobile terminal apparatus comprises information searching means for searching for additional information selected by operation performed by a user through plural pieces of additional information recorded in the memory, communication controlling means for acquiring, through the network, information relating to a television program based on the additional information found in the memory by the information searching means, and second record controlling means for recording in the memory the information relating to a television program acquired by the communication controlling means.

According to another aspect of the invention, there is provided a method of managing broadcast information, using a receiving apparatus for receiving digital broadcasts, a mobile terminal apparatus having a communication function for communicating with a network, and a memory for recording information, which method in the receiving apparatus comprises step A of extracting additional information when a predetermined operation is performed while receiving additional information for discriminating program information and information relating to a television program, step B of recording in the memory the additional information extracted in step A, step C of reading the information relating to a television program from the memory to display the read information on displaying means, when the information relating to a television program is recorded in the memory, and which method in the mobile terminal apparatus comprises step D of searching for additional information selected by operation performed by a user through plural pieces of additional information recorded in the memory, step E of acquiring, through the network, information relating to a television program based on the additional information found in the memory in step D, and step F of recording in the memory the information relating to a television program acquired in step E.

According to other aspect of the invention, there is provided a mobile terminal apparatus used in a broadcast information managing system comprising a memory for recording information; a receiving apparatus for receiving digital broadcasts, for extracting additional information when a predetermined operation is performed while receiving additional information for discriminating program information and information relating to a television program, and for recording the extracted additional information in the memory; and a handheld apparatus having a communication function for communicating with a network, which mobile terminal apparatus comprises information searching means for searching for additional information selected by operation performed by a user from among plural pieces of additional information stored in the memory, communication controlling means for acquiring, through the network, information relating to television program based on the additional information found by the information searching means, and record controlling means for recording in the memory the information relating to a television program acquired by the communication controlling means.

According to still other aspect of the invention, there is provided a receiving apparatus used in a broadcast information managing system comprising a receiver for receiving digital broadcasts, a memory for recording additional information for discriminating program information and information relating to a television program, and a mobile terminal apparatus having a communication function for communicating with a network, for searching for additional information designated by operation performed by a user through the memory, and for acquiring, through the network, information relating to a television program based on the additional information found in the memory, and for recording the acquired information relating to a television program in the memory, which receiving apparatus comprises information extracting means for extracting additional information when a predetermined operation is performed while receiving additional information for discriminating program information and information relating to a television program, record controlling means for recording in the memory the additional information extracted by the information extracting means, displaying means for displaying information, and display controlling means for reading the information relating to a television program from the memory to display the read information on the displaying means, when the information relating to a television program is recorded in the memory.

According to yet other aspect of the invention, there is provided a computer readable recording medium storing a computer program, applied for a receiving apparatus used in a broadcast information managing system comprising the receiving apparatus for receiving digital broadcasts, a memory mounted on the receiving apparatus, for recording additional information for discriminating program information and information relating to a television program, and a mobile terminal apparatus having a communication function for communicating with a network, for searching for additional information designated by operation performed by a user through the memory, and for acquiring, through the network, information relating to a television program based on the additional information found in the memory, and for recording the acquired information relating to a television program in the memory, which computer program is used for implementing steps including step D of searching for additional information designated by operation performed by a user through plural pieces of additional information recorded in the memory, step E of acquiring, through the network, information relating to a television program based on the additional information found in step D, and step F of recording in the memory the information relating to a television program acquired in step E.

According to yet another aspect of the invention, there is provided a computer readable recording medium storing a computer program, applied for a mobile terminal apparatus used in a broadcast information managing system comprising a memory for recording information, a receiving apparatus for receiving digital broadcasts, and for extracting additional information when a predetermined operation is performed while receiving additional information for discriminating program information and information relating to a television program, and for recording the extracted additional information in the memory, and the mobile terminal apparatus having a communication function for communicating with a network, which computer program is used for implementing steps including step A of extracting additional information when a predetermined operation is performed while receiving additional information for designating program information and information relating to a television program, step B of recording in the memory the additional information extracted in step A, and step C of reading the information relating to a television program from the memory to display the read information on displaying means, when the information relating to a television program is recorded in the memory.

### BRIEF DESCRIPTION OF THE DRAWINGS

FIG. 1 is a block diagram of a circuit configuration of a receiving apparatus according to the first and second embodiments of the present invention.

FIG. 2 is a block diagram of a circuit configuration of a cellular phone apparatus according to the first and second embodiments of the present invention.

FIG. 3 is a view illustrating a data format in a memory card shown in FIGS. 1 and 2.

FIG. 4 is a flow chart of operation of the receiving apparatus according to the first embodiment of the invention.

FIG. 5 is a flow chart of operation of the receiving apparatus, following that shown in FIG. 4.

FIG. 6 is a flow chart of operation of the receiving apparatus, following that shown in FIG. 5.

FIG. 7 is a flow chart of operation of the cellular phone apparatus according to the first embodiment of the invention.

FIG. 8 is a flow chart of operation of the receiving apparatus according to the second embodiment of the invention.

FIG. 9 is a flow chart of operation of the receiving apparatus, following that shown in FIG. 8.

FIG. 10 is a flow chart of operation of the receiving apparatus, following that shown in FIG. 9.

FIG. 11 is a flow chart of operation of the cellular phone apparatus according to the second embodiment of the invention.

### DETAILED DESCRIPTION OF THE PREFERRED EMBODIMENTS

Now, the first and second embodiments of a broadcast information managing system and a method of managing of broadcast information according to the present invention will be described. In particular, the broadcast information managing system and a method of managing of broadcast information, which are used in a terrestrial digital broadcasting receiver and a cellular phone widely used as a mobile terminal device, will be described in detail with reference to the accompanying drawings.

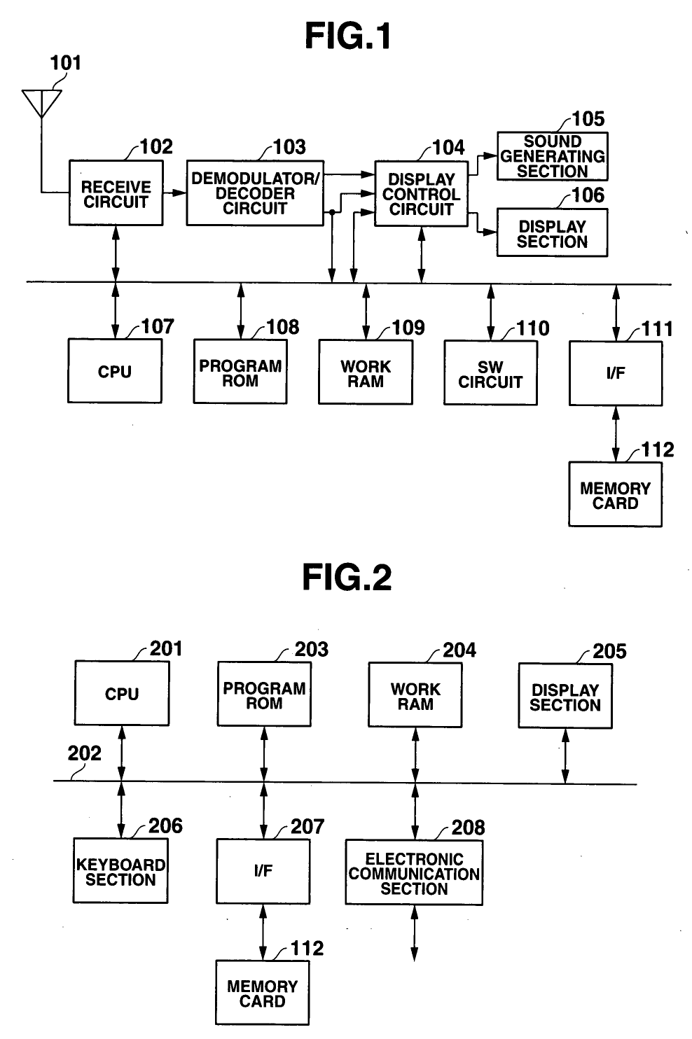

FIG. 1 is a block diagram of circuit configuration of a terrestrial digital broadcast receiving apparatus according to the embodiments of the invention. The broadcast receiving apparatus comprises a reproducing system including a television receiver section (“TV section”) and control system. First, the television receiver section will be described. In FIG. 1, radio frequency signals of the terrestrial digital broadcasting electromagnetic waves are input to a receiving circuit 102 through an antenna 101. The receiving circuit 102 amplifies the radio frequency signals input from the antenna 101, and selects a radio frequency signal from a particular broadcasting station in response to a channel selection command of the control section, and supplies the selected radio frequency signal to a demodulator/decoder circuit 103. The demodulator/decoder circuit 103 demodulates OFDM modulated radio frequency signal and further decodes the same into a base band signal, thereby separating the same signal into video information, audio information of a broadcasting program, and character information of a data broadcast. The separated pieces of information are supplied to a display control circuit 104. The display control circuit 104 executes D/A converting process and amplifying process on the audio information and outputs the thus processed audio information to a sound generating section 105. Meanwhile, the display control circuit 104 executes a color/luminance separating process, D/A converting process, and amplifying process on the video information and character information, and outputs the thus processed information to a display section 106.

Now, the control system of the receiving apparatus will be described. As shown in FIG. 1, CPU 107 is connected with the TV section via a system bus, and further connected with a program ROM 108, work RAM 109, switch circuit 110, and a card interface (I/F) 111 via the system bus. CPU 107 exchanges data and commands with these elements, thereby controlling whole operation of the broadcast receiving apparatus. More particularly, responding to a channel selecting operation of the switch circuit 110, CPU 107 sends the receiving circuit 102 a channel selection command. Further, responding to an acquisition operation of the switch circuit 110, CPU 107 acquires character information of the data broadcast from the demodulator/decoder circuit 103. In the program ROM 108 are previously stored a computer program for managing broadcast information and other computer programs to be executed by CPU 107. In the work RAM 109 are temporarily stored various sorts of data to be processed by CPU 107. The switch circuit 110 serves to input to CPU 107 operation contents of a switch group (not shown) provided on the receiving apparatus. Further, the switching circuit 107 receives infrared rays of operation contents sent from a remote controller (not shown) and inputs the received operation contents to CPU 107. The card interface 111 serves to store data on a memory card 112 detachably mounted on the receiving apparatus in response to a write command sent from CPU 107 and reads data from the memory card 112 in response to a read command from CPU 107.

FIG. 2 is a block diagram of circuit configuration of a cellular phone apparatus according to the embodiments of the invention. As shown in FIG. 2, CPU 201 is connected with a program ROM 203, work RAM 204, display section 205, keyboard section 206, card interface (I/F) 207, and an electronic communication section 208 via a system bus 202. CPU 201 exchanges data and commands with these elements, thereby controlling whole operation of the apparatus. In the program ROM 203 are previously stored a control program to be executed by CPU 201. In work RAM 204 are temporarily stored various sorts of data to be processed by CPU 201. The display section 205 displays data input by CPU 201. The keyboard section 206 inputs its operation contents to CPU 201. The card interface 207 serves to store data on the memory card 112 detachably mounted on the apparatus in response to a write command sent from CPU 201 and reads data from the memory card 112 in response to a read command sent from CPU 201. The memory card 112 is commonly used together with the receiving apparatus and cellular phone apparatus. The electronic communication section 208 accesses to terrestrial digital broadcasting sites through a network such as the Internet and acquires information relating to television programs. The acquired information is stored on the memory card 112 through the card interface 207 in response to the write command sent from CPU 201.

Note that a telephone function and mailing function of the cellular phone apparatus will not be described, since these functions do not directly relate to the features of the present invention.

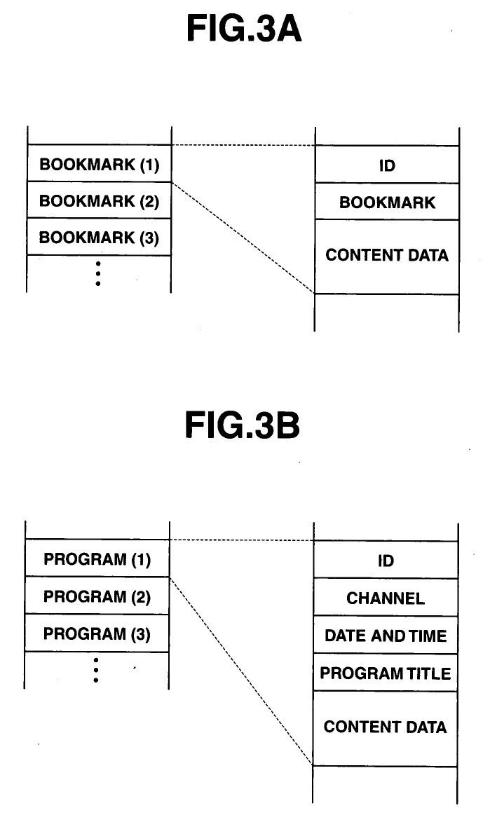

FIGS. 3A and 3B are views each illustrating a data format of data related to a television program stored on the memory card 112. FIG. 3A is a view illustrating a data format of data broadcast including a bookmark in the first embodiment. The data format consists of ID, bookmark, and content data. FIG. 3B is a view illustrating a data format of data broadcast including no bookmark in the second embodiment. The data format consists of ID, channel number, date and time of broadcast, program title, and content data.

A method of managing broadcast information executed in the first embodiment of the broadcast information managing system will be described.

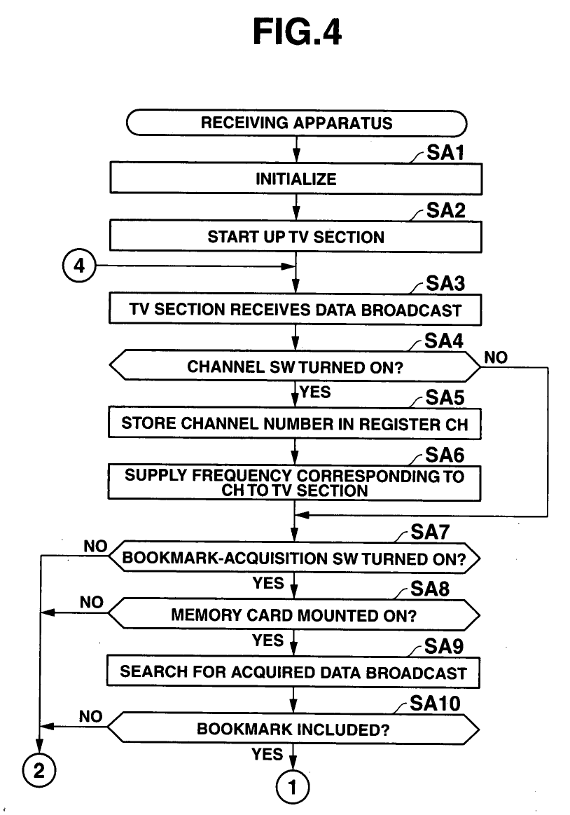

First, operation performed by CPU 107 in the receiving apparatus will be described referring to the flow charts shown in FIGS. 4 to 6.

CPU 107 executed a predetermined initializing process at step SA1 in FIG. 4, and starts up TV section at step SA2. TV section receives data broadcast at step SA3. CPU 107 judges at step SA4 whether or not a channel switch of the switch circuit 110 has been turned on. When the channel switch has been turned on (YES at step SA4), the appropriate channel number is stored in a register CH at step SA5, and a frequency corresponding to the channel number stored in the register CH is supplied to TV section as a channel-selection command at step SA6. CPU 107 judges at step SA7 whether or not a bookmark-acquisition switch of the switch circuit 110 has been turned on. When the bookmark-acquisition switch of the switch circuit 110 has been turned on (YES at step SA7), CPU 107 further judged at step SA8 whether or not the memory card 112 has been mounted on the apparatus. When the memory card 112 has been mounted on the apparatus (YES at step SA8), CPU 107 searches for the acquired data broadcast through the memory card 112 at step SA9, and further judges at step SA10 whether the acquired data broadcast includes a bookmark or not.

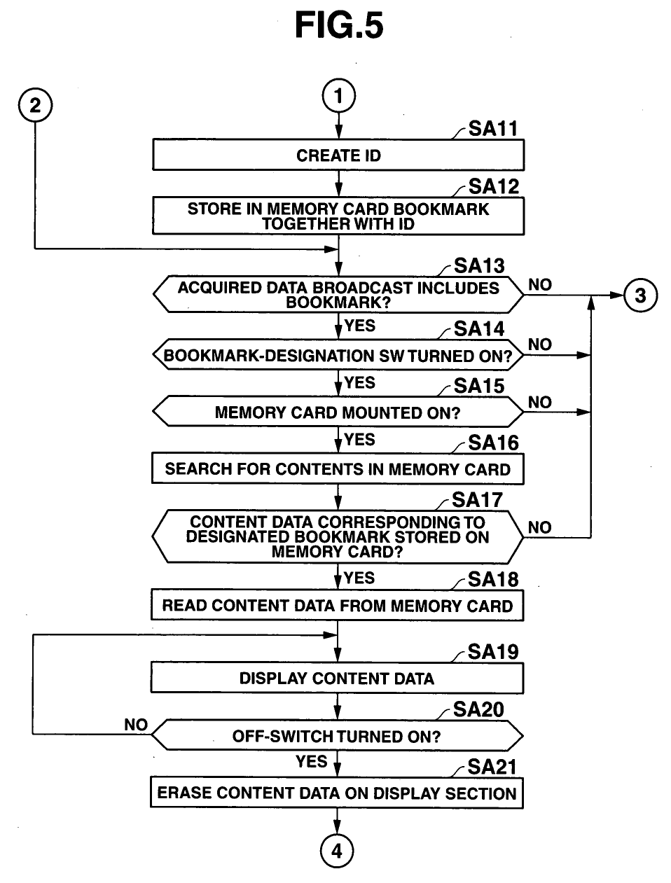

When the data broadcast includes a bookmark (YES at step SA10), CPU 107 creates ID for the bookmark at step SA11 in FIG. 5, and stores the bookmark together with the ID on the memory card 112 at step SA12. When the bookmark-acquisition switch of the switch circuit 110 has not been turned on (NO at step SA7 in FIG. 4), CPU 107 judges at step SA13 in FIG. 5 whether the acquired data broadcast includes a bookmark or not. When the acquired data broadcast includes a bookmark (YES at step SA13), CPU 107 judges at step SA14 whether a bookmark-designation switch has been turned on or not. When the bookmark-designation switch has been turned on (YES at step SA14), CPU 107 judges at step SA15 whether the memory card 112 has been mounted on the apparatus or not. When the memory card 112 has been mounted on the apparatus (YES at step SA15), CPU 107 searches for contents stored on the memory card 112 at step SA16, and judges at step SA17 whether or not content data corresponding to the designated bookmark is stored on the memory card 112.

When content data corresponding to the designated bookmark is included in the data broadcast, CPU 107 sends a command to the display control circuit 104 of TV section to read the content data from the memory card 112 at step SA18, and then displays the content data on the display section 106 at step SA19. CPU 107 judges at step SA20 with the content data displayed on the display section 106 whether an off-switch of the switch circuit 110 has been turned on or not. When the off-switch has been turned on (YES at step SA20), CPU 107 sends a command to the display control circuit 104 to erase the content data on the display section 106 at step SA21, and returns to step SA3 in FIG. 4, where CPU 107 makes TV section receive another data broadcast.

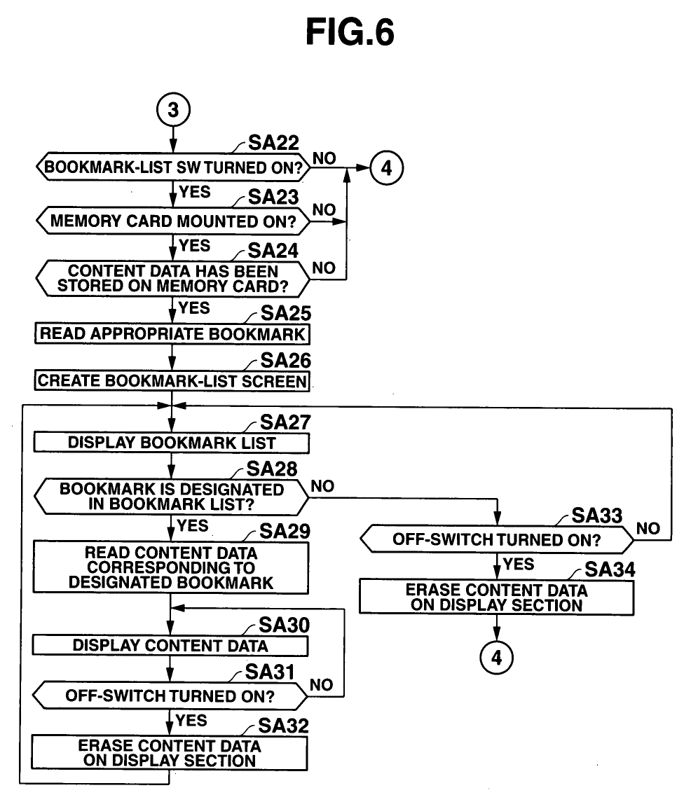

When the acquired data broadcast does not include a bookmark (NO at step SA13 in FIG. 5), or when the bookmark-designation switch has not been turned on (NO at step SA14), or when content data corresponding to the designated bookmark is not stored on the memory card 112 (NO at step SA17), CPU 107 judges at step SA22 in FIG. 6 whether a bookmark-list switch of the switch circuit 110 has been turned on or not. When the bookmark-list switch has been turned on (YES at step SA22), CPU 107 judges at step SA23 whether or not the memory card 112 has been mounted on the apparatus. When the memory card 112 has been mounted on the apparatus (YES at step SA23), CPU 107 judges at step SA24 whether at least one piece of content data has been stored on the memory card 112. When at least one piece of content data has been stored on the memory card 112 (YES at step SA24), CPU 107 reads a bookmark corresponding to the content data from the memory card 112 at step SA25, and creates a screen of a bookmark list at step SA26.

Then, CPU 107 sends the display control circuit 104 of TV section screen data of the bookmark list and a command, thereby displaying the screen of a bookmark list on display section 106 at step SA27. CPU 107 judges at step SA28 with the bookmark list displayed on the display section 106, whether or not a switch of the switch circuit 110 has been turned on to designate any one of bookmarks in the bookmark list. When a bookmark has been designated (YES at step SA28), CPU 107 reads content data corresponding to the designated bookmark from the memory card 112 at step SA29, and sends the display control section 104 of TV section the content data and a command to display the content data on the display section 106 at step SA30. CPU 107 judges at step SA31 with the content data displayed on the display section 106, whether or not the off-switch of the switch circuit 110 has been turned on. When the off-switch has been turned on (YES at step SA31), CPU 107 sends the display control circuit 104 a command to erase the content data displayed on the display section 106 at step SA32, and then returns to step SA27, where CPU 107 sends a command to the display control circuit 104 of TV section to display the bookmark list on the display section 106 again.

When the bookmark has not been designated (NO at step SA28), CPU 107 judges at step SA33 whether the off-switch of the switch circuit 110 has been turned on or not. When the off-switch has been turned on (YES at step SA33), CPU 107 sends a command to the display control circuit 104 to erase the content data displayed on the display section 106 at step SA34, and returns to step SA3 in FIG. 4, where CPU 167 makes TV section receive another data broadcast.

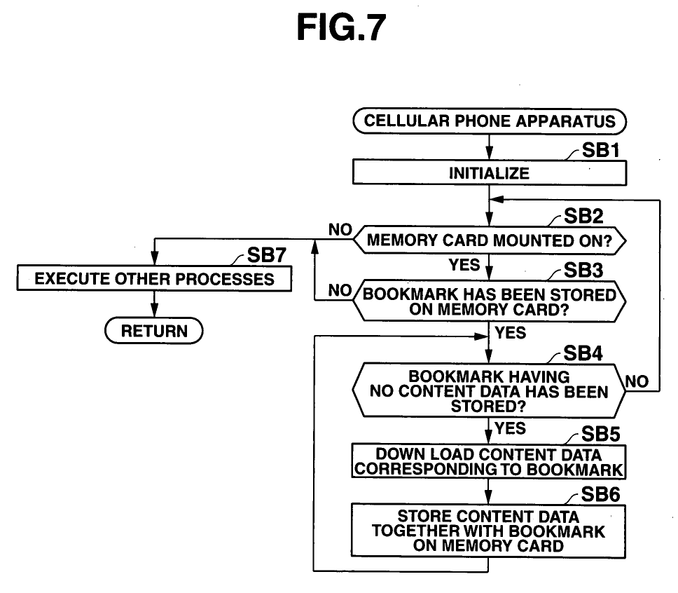

Now, operation of CPU 201 in the cellular phone apparatus will be described with reference to a flow chart shown in FIG. 7.

CPU 201 executes a predetermined initializing process at step SB1. Responding to operation of a memory-card read switch of the keyboard section 206, CPU 201 judges at step SB2 whether the memory card 112 has been mounted on the apparatus. When the memory card 112 has been mounted on the apparatus (YES at step SB2), CPU 201 judges at step SB3 whether a bookmark has been stored on the memory card 112 or not. When a bookmark has been stored on the memory card 112 (YES at step SB3), CPU 201 judges at step SB4 whether or not a bookmark having no appropriate content data has been stored on the memory card 112. When such bookmark having no appropriate content data has been stored on the memory card 112 (YES at step SB4), CPU 201 accesses to a terrestrial digital broadcasting station through the electronic communication section 208 using address information of such bookmark such as URL of Web page, and down loads content data corresponding to the bookmark at step SB5. CPU 201 stores the down loaded content data together with the bookmark on the memory card 112 at step SB6.

Thereafter, CPU 201 returns to step SB4, where CPU 201 judges again whether or not a bookmark having no appropriate content data has been stored on the memory card 112. When the bookmark having no appropriate content data has been stored on the memory card 112, CPU 201 down loads content data of such bookmark, and stores the content data together with the bookmark in the memory card 112. CPU 201 executes these processes repeatedly.

When the memory card 112 is not mounted on the apparatus (NO at step SB2), CPU 201 executes other processes such as a phone call receiving process, e-mail receiving process, process responding to operation of the key board section 206, and the like at step SB7.

As described above, in the first embodiment of the receiving apparatus, when the bookmark-acquisition switch of the switch circuit 110 is turned on during the process for receiving data broadcast for designating program information and content data, the bookmark is extracted from the data broadcast, and the extracted bookmark and ID are stored on the memory card 112.

Meanwhile, in the cellular phone apparatus, a bookmark designated by operation of the keyboard section 206 is searched for through the bookmarks stored on the memory card 112, which is removed from the receiving apparatus and mounted on the cellular phone apparatus, and the content data corresponding to the searched bookmark is acquired by the electronic communication section 208 through the net work. The acquired content data is stored on the memory card 112. Thereafter, the memory card 112 is removed from the cellular phone apparatus, and mounted on the receiving apparatus. The receiving apparatus displays the content data on the display section 106, when the memory card 112 stores such content data.

Therefore, using in combination a conventional receiving apparatus having no electronic communication function and conventional cellular phone apparatus having no receiving function for the digital broadcasts, a user can use data broadcasts which serve as additional information of the terrestrial digital broadcasts.

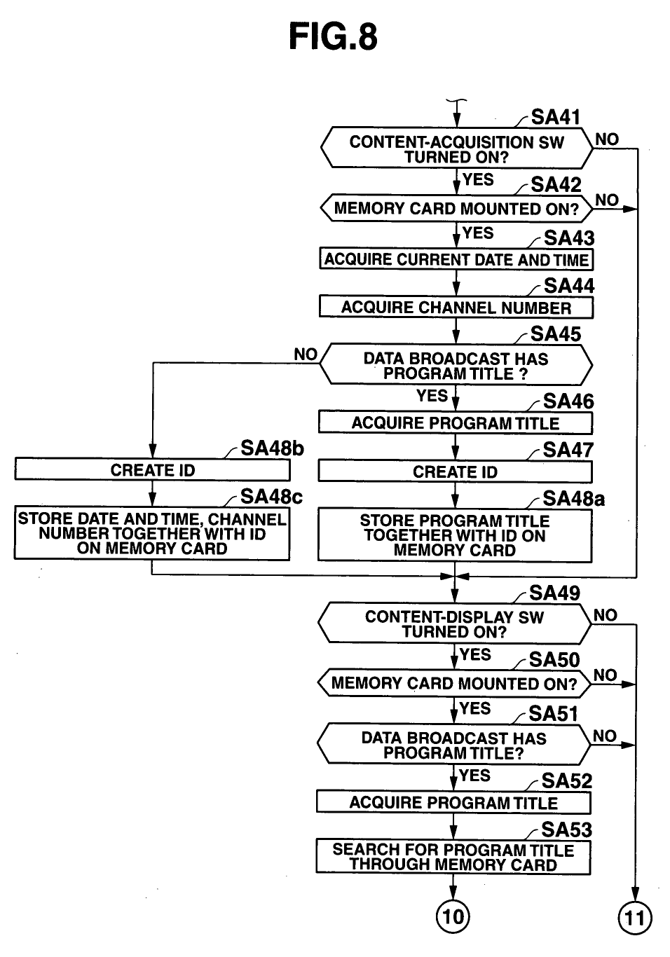

A method of managing broadcast information according to the second embodiment of the invention will be described referring to flow charts shown in FIGS. 8 to 10.

Operation of CPU 107 in the receiving apparatus will be described referring to flow charts in the second embodiment, shown in FIGS. 8 to 10 and a part of the flow chart in the first embodiment, shown in FIG. 4.

CPU 107 executes the predetermined initializing process at step SA1 in FIG. 4, and then starts up TV section at step SA2. TV section receives data broadcast at step SA3. CPU 107 judges at step SA4 whether the channel switch of the switch circuit 110 has been turned on or not. When the channel switch of the switch circuit 110 has been turned on (YES at step SA4), CPU 107 stores at step SA5 the channel number designated by operation of the channel switch on the register CH, and sends to TV section a frequency corresponding to the channel number stored on the register CH as the channel-selection command at step SA6.

Further, CPU 107 judges at step SA41 in FIG. 8 whether the content-acquisition switch of the switch circuit 110 has been turned on or not. When the content-acquisition switch has been turned on (YES at step SA41), CPU 107 judges at step SA42 whether or not the memory card 112 has been mounted on the apparatus. When the memory card 112 has been mounted on the apparatus (YES at step SA42), CPU 107 acquires the current date and time at step SA43, and acquires a channel number at step SA44, and judges at step SA45 whether data broadcast includes a program title or not.

When the data broadcast includes the program title (YES at step SA45), CPU 107 acquires the program title of the data broadcast at step SA46, and creates ID at step SA47, and stores the program title of the data broadcast together with ID on the memory card 112 at step SA48a. Meanwhile, when the data broadcast includes no program title (NO at step SA45), CPU 107 creates ID at step SA47b, and stores a date and time, and channel number together with the created ID on the memory card 112 at step SA48c. When the content-acquisition switch of the switch circuit 110 has not been turned on (NO at step SA41), CPU 107 judges at step SA49 whether a content-display switch of the switch circuit 110 has been turned on or not. When the content-display switch has been turned on (YES at step SA49), CPU 107 judges at step SA50 whether the memory card 112 has been mounted on the apparatus. When the memory card 112 has been mounted on the apparatus (YES at step SA50), CPU 107 judges at step SA51 whether data broadcast has a program title or not. When the data broadcast has a program title (YES at step SA51), CPU 107 acquires the program title of the data broadcast at step SA52, and searches for the program title of the data broadcast through data stored on the memory card 112 at step SA53.

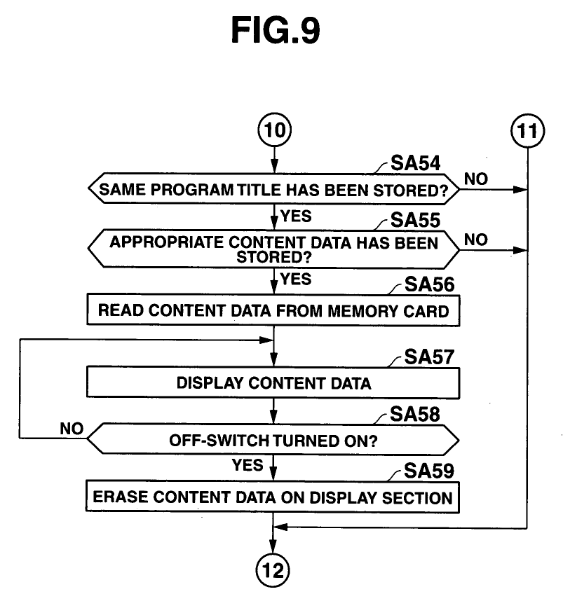

CPU 107 judges at step SA54 in FIG. 9 whether the same program title as the data broadcast has been stored on the memory card 112. When the same program title has been stored on the memory card 112 (YES at step SA54), CPU 107 judges at step SA55 whether or not content data corresponding to the program title has been stored on the memory card 112. When content data corresponding to the program title has been stored on the memory card 112 (YES at step SA55), CPU 107 reads the content data from the memory card 112 at step SA56, and sends the display control section 104 the content data together with a command to display the content data on the display section 106 at step SA57. CPU 107 judges at step SA58 with the content data displayed on the display section 106 whether or not the off-switch of the switch circuit 110 has been turned on. When the off-switch has been turned on (YES at step SA58), CPU 107 sends a command to the display control section 104 to erase the content data displayed on the display section 106 at step SA59.

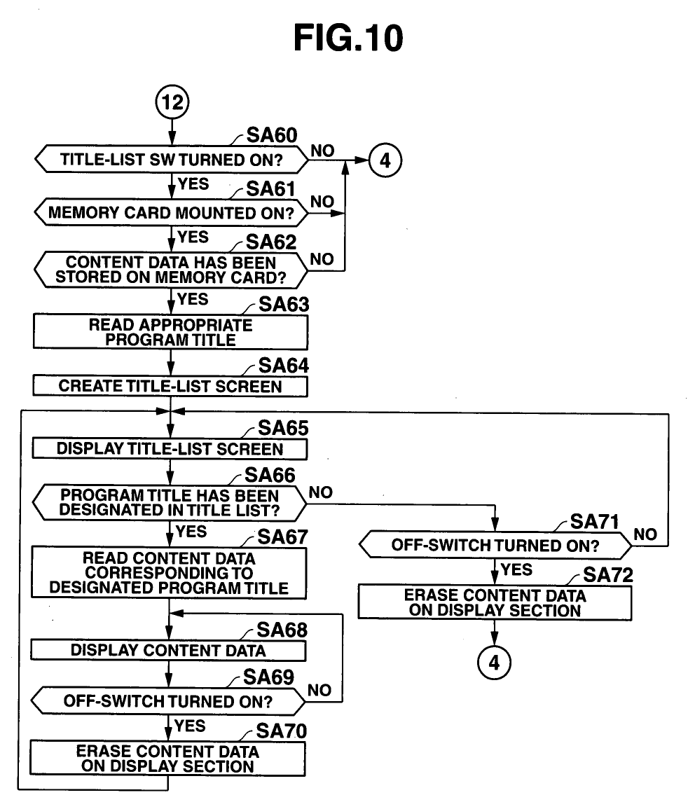

When the content-display switch of the switch circuit 110 has not been turned on (NO at step SA49 in FIG. 8), CPU 107 judges at step SA60 in FIG. 10 whether a title-list switch of the switch circuit 110 has been turned on. When the title-list switch of the switch circuit 110 has been turned on (YES at step SA60), CPU 107 judges at step SA61 whether the memory card 112 has been mounted on the apparatus. When the memory card 112 has been mounted on the apparatus (YES at step SA61), CPU 107 judges at step SA62 whether content data has been stored on the memory card 112. When content data has been stored on the memory card 112 (YES at step SA62), CPU 107 reads a program title corresponding to the content data at step SA63, and creates a title-list screen at step SA64.

Then, CPU 107 sends data of the title-list screen and a command to the display control circuit 104 of TV section to display a title list on the display section 106 at step SA65. CPU 107 judges at step SA66 with the title list displayed on the display section 106 whether or not any of program titles in the title list has been designated by operation of the switch of the switch circuit 110. When a program title has been designated (YES at step SA66), CPU 107 reads content data corresponding to the program title from the memory card 112 at step SA67, and sends the content data and a command to the display control circuit 104 of TV section to display the content data on the display section 106 at step SA68. CPU 107 judges at step SA69 with the content data displayed on the display section 106 whether or not the off-switch of the switch circuit 110 has been turned on. When the off-switch of the switch circuit 110 has been turned on (YES at step SA69), CPU 107 sends a command to the display control circuit 104 to erase the content data on the display section 106 at step SA70. Then, CPU 107 returns to step SA65, where CPU 107 sends a command to the display circuit 104 again to display the title list on the display section 106.

When no program title has been designated among the title list (NO at step SA66), CPU 107 judges at step SA71 whether or not the off-switch of the switch circuit 110 has been turned on. When the off-switch has been turned on (YES at step SA71), CPU 107 sends a command to the display control circuit 104 to erase the content data displayed on the display section 106 at step SA72, and returns to step SA3 in FIG. 4, where CPU 107 makes TV section receive another data broadcast.

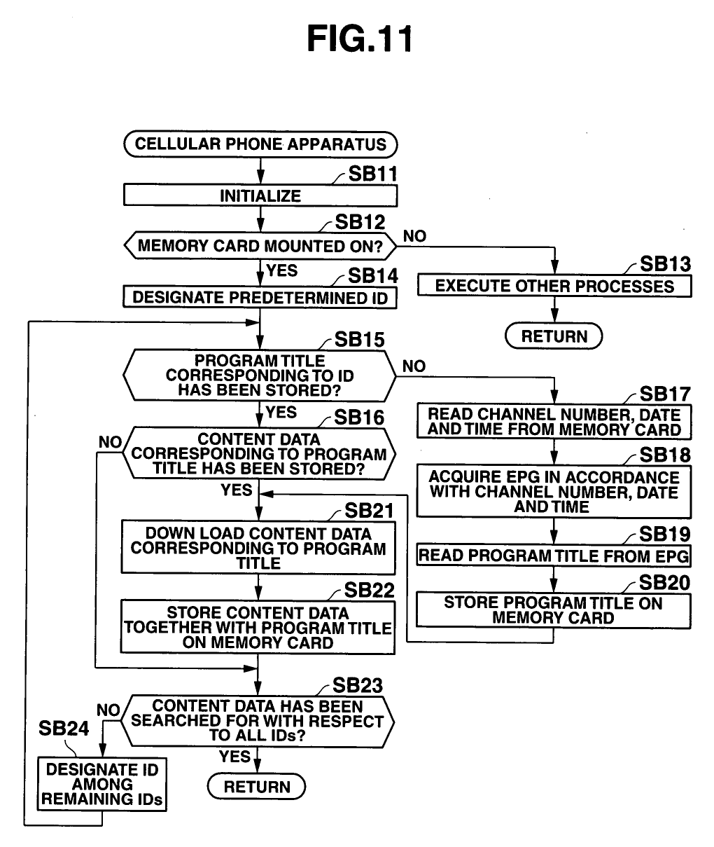

Now, operation of CPU 201 in the cellular phone apparatus will be described with reference to a flow chart shown in FIG. 11.

CPU 201 executes the predetermined initializing process at step SB11, and judges at step SB12 in response to operation of memory-card read switch of the keyboard section 206, whether the memory card 112 has been mounted on the apparatus or not. When the memory card 112 is not mounted on the apparatus (NO at step SB12), CPU 201 executes other processes such as a phone call receiving process, e-mail receiving process, transmission process, and the like responding to operation of the keyboard section 206 at step SB13. Meanwhile, when the memory card 112 has been mounted on the apparatus (YES at step SB12), CPU 201 designates a predetermined ID, for example, ID of the first program title (1) at step SB14, and judges at step SB15 whether or not a program title corresponding to the designated ID has been stored on the memory card 112. When the program title has been stored on the memory card 112 (YES at step SB15), CPU 201 further judges at step SB16 whether or not content data corresponding to the program title has been stored on the memory card 112.

When the program title corresponding to the designated ID has not been stored on the memory card 112 (NO at step SB15), CPU 201 reads a channel number and date and time from the memory card 112 at step SB17. CPU 201 accesses to a terrestrial digital broadcasting site through the electronic communication section 208 in accordance with the channel number and date and time, thereby acquiring appropriate EPG (Electronic Program Guide) at step SB18. Then, CPU 201 reads a program title from the acquired EPG at step SB19 and stores the program title on the memory card 112 at step SB20.

When the content data corresponding to the program title has been stored on the memory card 112 (YES at step SB16), or after the program title acquired based on EPG has been stored on the memory card 112 at step SB20, CPU 201 accesses to a terrestrial digital broadcasting site through the electronic communication section 208 in accordance with address information included in EPG such as URL of Web page, and down loads content data corresponding to the program title at step SB21. The down loaded content data is stored on the memory card 112 together with the program title at step SB22.

After the content data has been stored on the memory card 112 together with the program title at step SB22, or when the content data corresponding to the program title is not stored on the memory card 112 (NO at step SB16), CPU 201 judges at step SB23 whether or not content data corresponding to the program title has been searched for with respect to all the IDs. When content data corresponding to the program title has not yet been searched for with respect to some IDs (NO at step SB23), CPU 201 designates at step SB24 one ID among remaining IDs, with respect to which ID content data has not been searched for, and returns to step SB15, where CPU 201 judges whether or not a program title corresponding to the designated ID has been stored on the memory card 112. CPU 201 repeatedly executes processes at steps SB15 to SB23 until content data has been searched for with respect to all the IDs.

As described above, in the receiving apparatus according the second embodiment of the present invention, when the content-acquisition switch of the switch circuit 110 has been turned on while the receiving apparatus is receiving data broadcast for discriminating program information and content data, and when such data broadcast has a program title, then the program tile is stored on the memory card 112 together with the appropriate ID. When such data broadcast has no program title, a date and time, and a channel number are stored on the memory card 112 together with the ID.

Then, the memory card 112 is removed from the receiving apparatus and mounted on the cellular phone apparatus. The cellular phone apparatus is connected to the network through the electronic communication section 208, and acquires content data based on the program title, the date and time, and channel number stored on the memory card 112. The acquired content data is stored on the memory card 112. Thereafter, the memory card 112 is removed from the cellular phone apparatus and mounted on the receiving apparatus, again. When program related information is stored on the memory card 112, the receiving apparatus displays such program related information on the display section 106.

Therefore, using combination of a conventional receiving apparatus having no electronic communication function and a conventional mobile terminal apparatus having no receiving function for the digital broadcasts, the user can enjoy data broadcasts which serve as additional information of the terrestrial digital broadcasts.

In the embodiments described above, the present invention is described referring to the apparatus for receiving data broadcasts which serve as additional information of the terrestrial digital broadcasts. But the present invention is not restricted to the techniques for receiving the terrestrial digital broadcasts. In the case where satellite digital TV broadcasts or digital radio broadcasts from broadcast satellites (BS) and/or telecommunications satellites (CS) are received, the receiving apparatus and method of the present invention can be used in the similar manner. The user can enjoy data broadcasts which serve as additional information of these digital broadcasts.

In the embodiments described above, the present invention is described referring to the cellular phone apparatus serving as a mobile terminal apparatus. But in the present invention, the mobile terminal apparatus is by no means restricted to the cellular phone apparatus. Another mobile terminal apparatuses such as PHS and PDA (Personal Digital Assistants) which are capable of accessing to networks such as the Internet may be used to realize the broadcast program managing system of the present invention.

In the embodiments described above, the present invention is described referring to the receiving apparatus and cellular phone apparatus with storage medium detachably mounted thereon, such as a memory card. The storage medium is not restricted to the memory card. For example, memory tips of a USB type may be used in a receiving apparatus and cellular phone apparatus which are provided with interfaces of a USB type. Modification may be made that the receiving apparatus and cellular phone apparatus are connected with each other through USB cable or IEEE 1394 cable to exchange data between respective work RAMs.

More specifically, modification may be made that the bookmark stored on the work RAM 109 of the receiving apparatus in FIG. 1 is transferred to the work RAM 204 of the cellular phone apparatus in FIG. 2, and that the cellular phone apparatus down loads and stores content data corresponding to the bookmark on work RAM 204. Thereafter, the content data stored on the work RAM 204 of the cellular phone apparatus is transferred to the work RAM 109 of the receiving apparatus, and the display control circuit 104 of the receiving apparatus displays the content data on the display section 106.

Therefore, using the above arrangement including a conventional receiving apparatus having no electronic communication function and a conventional mobile terminal apparatus having no receiving function for the digital broadcasts, the user can enjoy data broadcasts which serve as additional information of the terrestrial digital broadcasts.

In short, the above described embodiments are given as examples to realize the spirit of the present invention, and therefore, any modification and/or alternation that may easily be made to the embodiments by those skilled in the art will fall, within the scope of the present invention as far as they are not apart from the technical idea of the present invention as defined in the claims of the present patent application.

What is claimed is:

1. A broadcast information managing system comprising a receiving apparatus for receiving digital broadcasts; a mobile terminal apparatus having a communication function for communicating with a network; and a memory for storing information, wherein the receiving apparatus comprises:
information extracting means for extracting additional information when a predetermined operation is performed while receiving additional information for designating program information and information relating to a television program;
first record controlling means for recording in the memory the additional information extracted by the information extracting means;
displaying means for displaying information; and
display controlling means for reading the information relating to a television program from the memory to display the read information on the displaying means, when the information relating to a television program is recorded in the memory, and the mobile terminal apparatus comprises:
information searching means for searching for additional information selected by operation performed by a user through plural pieces of additional information recorded in the memory;
communication controlling means for acquiring, through the network, information relating to a television program based on the additional information found in the memory by the information searching means; and
second record controlling means for recording in the memory the information relating to a television program acquired by the communication controlling means.

2. The broadcast information managing system according to claim 1, wherein, in the receiving apparatus,
the information extracting means extracts address information on the network included in the additional information, and the first record controlling means records in the memory the address information extracted by the information extracting means; and in the mobile terminal apparatus,
the information searching means searches for address information through the memory, and the communication controlling means acquires information relating to a television program based on the address information found in the memory by the information searching means.

3. The broadcast information managing system according to claim 1, wherein, in the receiving apparatus,
the information extracting means extracts program-title information included in the additional information, and the first record controlling means records in the memory the program-title information extracted by the information extracting means; and in the mobile terminal apparatus,
the information searching means searches for program-title information through the memory, and the communication controlling means acquires information relating to a television program based on the program-title information found in the memory by the information searching means.

4. The broadcast information managing system according to claim 1, wherein, in the receiving apparatus,
the information extracting means extracts current date and time information and channel information included in the additional information, and the first record controlling means records in the memory the current date and time information and channel information extracted by the information extracting means; and in the mobile terminal apparatus,
the information searching means searches through the memory for current date and time information and channel information, and the communication controlling means acquires electronic program guide information based on the current date and time information and channel information found in the memory by the information searching means, and further acquires information relating to a television program based on a program title included in the acquired electronic program guide information.

5. The broadcast information managing system according to claim 1, wherein the memory can be used commonly both in the receiving apparatus and in the mobile terminal apparatus, and detachably be mounted on the receiving apparatus and also on the mobile terminal apparatus.

6. A method of managing broadcast information, using a receiving apparatus for receiving digital broadcasts, a mobile terminal apparatus having a communication function for communicating with a network and a memory for recording information, the method in the receiving apparatus comprising:
step A of extracting additional information when a predetermined operation is performed while receiving additional information for discriminating program information and information relating to a television program;
step B of recording in the memory the additional information extracted in step A;
step C of reading the information relating to a television program from the memory to display the read information on displaying means, when the information relating to a television program is recorded in the memory, and the method in the mobile terminal apparatus comprising:
step D of searching for additional information selected by operation performed by a user through plural pieces of additional information recorded in the memory;
step E of acquiring, through the network, information relating to a television program based on the additional information found in the memory in step D; and
step F of recording in the memory the information relating to a television program acquired in step E.

7. The method of managing broadcast information, according to claim 6, wherein, in the receiving apparatus,
in step A, address information on the network is extracted from the additional information, and in step B, the address information extracted in step A is recorded in the memory; and in the mobile terminal apparatus,
in step D, address information is searched for through the memory, and in step E, information relating to a television program is acquired based on the address information found in the memory in step D.

8. The method of managing broadcast information, according to claim 6, wherein, in the receiving apparatus,
in step A, program-title information is extracted from the additional information, and in step B, the program-title information extracted in step A is recorded in the memory; and in the mobile terminal apparatus,
in step D, program-title information is searched for through the memory, and in step E, information relating to a television program is acquired based on the program-title information found in the memory in step D.

9. The method of managing broadcast information, according to claim 6, wherein, in the receiving apparatus,
in step A, current date and time information and channel information are extracted from the extracted additional information; and in step B, the program-title information extracted in step A is recorded in the memory; and in the mobile terminal apparatus,
in step D, program-title information is searched for through the memory, and in step E, electronic program guide information is acquired based on the current date and time information and channel information found in the memory in step D and further information relating to a television program is acquired based on a program title included in the acquired electronic program guide information.

10. The method of managing broadcast information, according to claim 6, wherein the memory can be used commonly both in the receiving apparatus and in the mobile terminal apparatus, and detachably be mounted on the receiving apparatus and also on the mobile terminal apparatus.

11. A mobile terminal apparatus used in a broadcast information managing system comprising a memory for recording information; a receiving apparatus for receiving digital broadcasts, for extracting additional information when a predetermined operation is performed while receiving additional information for discriminating program information and information relating to a television program, and for recording the extracted additional information in the memory; and a handheld apparatus having a communication function for communicating with a network, the mobile terminal apparatus comprising:
information searching means for searching for additional information selected by operation performed by a user from among plural pieces of additional information stored in the memory;
communication controlling means for acquiring, through the network, information relating to television program based on the additional information found by the information searching means; and
record controlling means for recording in the memory the information relating to a television program acquired by the communication controlling means.

12. The mobile terminal apparatus according to claim 11, wherein the information searching means searches for address information through the memory, and the communication controlling means acquires information relating to a television program based on the address information found in the memory by the information searching means.

13. The mobile terminal apparatus according to claim 11, wherein the information searching means searches for program-title information through the memory, and the communication controlling means acquires information relating to a television program based on the program-title information found in the memory by the information searching means.

14. The mobile terminal apparatus according to claim 11, wherein, in the receiving apparatus, current date and time information and channel information are extracted from the additional information and recorded in the memory; and in the mobile terminal apparatus, the information searching means searches for current date and time information and channel information through the memory, and the communication controlling means acquires electronic program guide information based on the current date and time information and channel information found in the memory by the information searching means, and further acquires information relating to a television program based on a program title included in the acquired electronic program guide information.

15. The mobile terminal apparatus according to claim 11, wherein the memory can be used commonly both in the receiving apparatus and in the mobile terminal apparatus, and detachably be mounted on the receiving apparatus and also on the mobile terminal apparatus.

16. A receiving apparatus used in a broadcast information managing system comprising a receiver for receiving digital broadcasts, a memory for recording additional information for discriminating program information and information relating to a television program, and a mobile terminal apparatus having a communication function for communicating with a network, for searching through the memory for additional information designated by operation performed by a user, and for acquiring, through the network, information relating to a television program based on the additional information found in the memory, and for recording the acquired information relating to a television program in the memory, the receiving apparatus comprising:
information extracting means for extracting additional information when a predetermined operation is performed while receiving additional information for discriminating program information and information relating to a television program;
record controlling means for recording in the memory the additional information extracted by the information extracting means;
displaying means for displaying information; and
display controlling means for reading the information relating to a television program from the memory to display the read information on the displaying means, when the information relating to a television program is recorded in the memory.

17. The receiving apparatus according to claim 16, wherein the information extracting means extracts address information on the network included in the additional information.

18. The receiving apparatus according to claim 16, wherein the information extracting means extracts program-title information included in the additional information.

19. The receiving apparatus according to claim 16, wherein the information extracting means extracts current date and time information and channel information included in the additional information.

20. The receiving apparatus according to claim 16, wherein the memory can be used commonly both in the receiving apparatus and in the mobile terminal apparatus, and detachably be mounted on the receiving apparatus and also on the mobile terminal apparatus.

21. A computer readable recording medium storing a computer program, applied for a receiving apparatus used in a broadcast information managing system comprising the receiving apparatus for receiving digital broadcasts; a memory mounted on the receiving apparatus, for recording additional information for discriminating program information and information relating to a television program; and a mobile terminal apparatus having a communication function for communicating with a network, for searching for additional information designated by operation performed by a user through the memory, and for acquiring, through the network, information relating to a television program based on the additional information found in the memory, and for recording the acquired information relating to a television program in the memory, the computer program used for implementing steps of:
step D of searching for additional information designated by operation performed by a user through plural pieces of additional information recorded in the memory;
step E of acquiring, through the network, information relating to a television program based on the additional information found in step D; and
step F of recording in the memory the information relating to a television program acquired in step E.

22. A computer readable recording medium storing a computer program, applied for a mobile terminal apparatus used in a broadcast information managing system comprising a memory for recording information; a receiving apparatus for receiving digital broadcasts, and for extracting additional information when a predetermined operation is performed while receiving additional information for discriminating program information and information relating to a television program, and for recording the extracted additional information in the memory; and the mobile terminal apparatus having a communication function for communicating with a network, the computer program used for implementing steps of:
step A of extracting additional information when a predetermined operation is performed while receiving additional information for designating program information and information relating to a television program;
step B of recording in the memory the additional information extracted in step A; and
step C of reading the information relating to a television program from the memory to display the read information on displaying means, when the information relating to a television program is recorded in the memory.
